(19) United States
(12) Patent Application Publication
(10) Pub. No.: US 2019/0088158 A1
(43) Pub. Date: Mar. 21, 2019

(54) SYSTEM, METHOD AND COMPUTER PROGRAM PRODUCT FOR AUTOMATIC PERSONALIZATION OF DIGITAL CONTENT

(71) Applicant: BEE3EE SRL., Calci, OT (IT)

(72) Inventors: RICCHETTI Remo, Calci, OT (IT); BRODI Maria Gabriella, Bedford Hills, NY (US); FRIED Eyal, Haifa (IL)

(21) Appl. No.: 15/768,566

(22) PCT Filed: Oct. 19, 2016
(86) PCT No.: PCT/IL2016/051130

§ 371 Date: Apr. 16, 2018

Related U.S. Application Data
(60) Provisional application No. 62/244,545, filed on Oct. 21, 2015.

(51) Int. Cl. G09B 17/00; G09B 5/06

(52) U.S. Cl. CPC G09B 17/003; G09B 5/06

(57) ABSTRACT

A system for creating a user reading profile, the system comprising a processor configured to: obtain one or more reading-related inputs relating to reading, by a user, of content displayed to the user, the content comprising one or more elements, and the reading-related inputs obtained during reading of the content by the user; compare the received reading-related inputs to corresponding expected values for identifying one or more reading-related insights; and create a user reading profile, utilizing the reading-related insights.

### TECHNICAL FIELD

The invention relates to a system and method for automatic personalization of digital content, and more specifically for automatic personalization of digital content based on characterization of users.

### BACKGROUND

Much of the content consumed nowadays via user devices (such as smart phones, tablets, laptop or desktop computers, smart televisions, as well as other computerized devices suitable for presenting text to users) is at least partially textual, and is consumed by the user through reading. Despite the fact that technological advancements have contributed to the proliferation of reading via such user devices, display-mediated reading is still an extremely tiresome experience with high cognitive load and often low comprehension levels, particularly when needing to process lengthy segments of text or when external conditions are not optimal. Just as importantly, unlike other forms of user interaction, current reading applications acquire very limited information as to their users' behaviors and habits relating to the way content is being consumed, as well as to the user's mental state as they interact with the textual content.

There is thus a need in the art for a new method and system for automatic personalization of digital content.

### GENERAL DESCRIPTION

In accordance with a first aspect of the presently disclosed subject matter there is provided a system for creating a user reading profile, the system comprising a processor configured to: obtain one or more reading-related inputs relating to reading, by a user, of content displayed to the user, the content comprising one or more elements, and the reading-related inputs obtained during reading of the content by the user; compare the received reading-related inputs to corresponding expected values for identifying one or more reading-related insights; and create a user reading profile, utilizing the reading-related insights.

In some cases, the reading-related insights include one or more classified error-related insights associated with the corresponding elements of the content, the classified error-related insights being classified by the processor according to one or more classes of reading errors, and wherein the user reading profile is indicative of a likelihood of the user performing each class of the classes of reading errors.

In some cases, the processor is further configured to determine, based on the user reading profile, one or more manipulations to be performed on a subsequent content when presented to the user, for reducing the likelihood of the user performing subsequent reading errors when reading the subsequent content, wherein performing the manipulations gives rise to manipulated subsequent content.

In some cases, the processor is further configured to determine one or more second manipulations to be performed on the subsequent content, based on a second user reading profile, associated with a second user, for reducing the likelihood of the second user performing reading errors when reading the subsequent content, wherein performing the second manipulations gives rise to second manipulated subsequent content and wherein the manipulated subsequent content is visually different than the second manipulated subsequent content.

In some cases, the manipulations include one or more of: changing size of at least part of one or more subsequent elements of the subsequent content; changing the font style of at least part of one or more subsequent elements of the subsequent content; changing the font family of at least part of one or more subsequent elements of the subsequent content; changing the font color of at least part of one or more subsequent elements of the subsequent content; changing the case of at least part of one or more subsequent elements of the subsequent content; highlighting at least part of one or more subsequent elements of the subsequent content; replacing one or more subsequent elements of the subsequent content with an image.

In some cases, the image is indicative of a meaning of the element.

In some cases, the image is one of the following: an icon; an animated gif; a hyperlink.

In some cases, the processor is further configured to provide feedback to the user when identifying the reading errors.

In some cases, the feedback includes one or more of the following: an error notification; requesting the user to re-read the element associated with the reading error; changing size of at least part of one or more elements; changing the font style of at least part of one or more elements; changing the font family of at least part of one or more elements; changing the font color of at least part of one or more elements; changing the case of at least part of one or more elements; highlighting at least part of one or more elements; replacing one or more elements with an image; playing a correct pronunciation of at least part of one or more element via a speaker; establishing an interaction between the user and an authorized user.

In some cases, the image is indicative of a meaning of the element.

In some cases, the image is one of the following: an icon; an animated gif; a hyperlink.

In some cases, the reading-related inputs are obtained using one or more sensors of a user device operated by the user.

In some cases, the sensors include one or more of the following: a touch sensor; a microphone; a pressure sensor; a camera; a Galvanic Skin Response (GSR) sensor; a heart rate sensor; a pulse sensor.

In some cases, the reading-related inputs include an indication of a current reading position obtained utilizing the touch sensor and wherein the corresponding expected value is an expected current reading position.

In some cases, the reading related-inputs include a voice-to-text value of an audio recording of the user's voice reading a given element of the elements, the audio recording obtained utilizing the microphone, and wherein the corresponding expected value is an expected text.

In some cases, the voice-to-text value is obtained automatically using an automatic voice-to-text converter.

In some cases, the reading-related inputs include an indication of a current applied pressure obtained utilizing the pressure sensor and wherein the corresponding expected value is an expected current applied pressure.

In some cases, the reading-related inputs include a value indicative of a current mental status obtained by automatically analyzing an image of the user's face, the image obtained utilizing the camera, and wherein the corresponding expected value is indicative of an expected current mental status.

In some cases, the classes of reading errors includes one or more of: addition of words or syllables or letters; omission of words or syllables or letters; miscue of words or syllables or letters; a pause before reading words or syllables or letters; repetition of words or syllables or letters; mispronunciation of words or syllables or letters.

In some cases, the processor is further configured to determine, based on the user reading profile, a recommendation for one or more subsequent contents to read, out of a plurality of available contents.

In some cases, the processor is part of a user device operated by the user.

In some cases, the processor is external to a user device operated by the user.

In some cases, at least one element of the elements is a visual representation indicative of a meaning of a word.

In some cases, at least one element of the elements is a textual element.

In some cases, the content is a textual content and wherein the elements are textual.

In some cases, the manipulations are visual manipulations.

In some cases, the manipulations and the second manipulations are visual manipulations.

In accordance with a second aspect of the presently disclosed subject matter there is provided a method of creating a user reading profile, the method comprising: obtaining one or more reading-related inputs relating to reading, by a user, of content displayed to the user, the content comprising one or more elements, and the reading-related inputs obtained during reading of the content by the user; comparing, by a processor, the received reading-related inputs to corresponding expected values for identifying one or more reading-related insights; and creating a user reading profile, utilizing the reading-related insights.

In some cases, the reading-related insights include one or more classified error-related insights associated with the corresponding elements of the content, the classified error-related insights being classified by the processor according to one or more classes of reading errors, and wherein the user reading profile is indicative of a likelihood of the user performing each class of the classes of reading errors.

In some cases, the method further comprises determining, based on the user reading profile, one or more manipulations to be performed on a subsequent content when presented to the user, for reducing the likelihood of the user performing subsequent reading errors when reading the subsequent content, wherein performing the manipulations gives rise to manipulated subsequent content.

In some cases, the method further comprises determining one or more second manipulations to be performed on the subsequent content, based on a second user reading profile, associated with a second user, for reducing the likelihood of the second user performing reading errors when reading the subsequent content, wherein performing the second manipulations gives rise to second manipulated subsequent content and wherein the manipulated subsequent content is visually different than the second manipulated subsequent content.

In some cases, the manipulations include one or more of: changing size of at least part of one or more subsequent elements of the subsequent content; changing the font style of at least part of one or more subsequent elements of the subsequent content; changing the font family of at least part of one or more subsequent elements of the subsequent content; changing the font color of at least part of one or more subsequent elements of the subsequent content; changing the case of at least part of one or more subsequent elements of the subsequent content; highlighting at least part of one or more subsequent elements of the subsequent content; replacing one or more subsequent elements of the subsequent content with an image.

In some cases, the image is indicative of a meaning of the element.

In some cases, the image is one of the following: an icon; an animated gif; a hyperlink.

In some cases, the method further comprises providing feedback to the user when identifying the reading errors.

In some cases, the feedback includes one or more of the following: an error notification; requesting the user to re-read the element associated with the reading error; changing size of at least part of one or more elements; changing the font style of at least part of one or more elements; changing the font family of at least part of one or more elements; changing the font color of at least part of one or more elements; changing the case of at least part of one or more elements; highlighting at least part of one or more elements; replacing one or more elements with an image; playing a correct pronunciation of at least part of one or more element via a speaker; establishing an interaction between the user and an authorized user.

In some cases, the image is indicative of a meaning of the element.

In some cases, the image is one of the following: an icon; an animated gif; a hyperlink.

In some cases, the reading-related inputs are obtained using one or more sensors of a user device operated by the user.

In some cases, the sensors include one or more of the following: a touch sensor; a microphone; a pressure sensor; a camera; a Galvanic Skin Response (GSR) sensor; a heart rate sensor; a pulse sensor.

In some cases, the reading-related inputs include an indication of a current reading position obtained utilizing the touch sensor and wherein the corresponding expected value is an expected current reading position.

In some cases, the reading related-inputs include a voice-to-text value of an audio recording of the user's voice reading a given element of the elements, the audio recording obtained utilizing the microphone, and wherein the corresponding expected value is an expected text.

In some cases, the voice-to-text value is obtained automatically using an automatic voice-to-text converter.

In some cases, the reading-related inputs include an indication of a current applied pressure obtained utilizing the pressure sensor and wherein the corresponding expected value is an expected current applied pressure.

In some cases, the reading-related inputs include a value indicative of a current mental status obtained by automatically analyzing an image of the user's face, the image obtained utilizing the camera, and wherein the corresponding expected value is indicative of an expected current mental status.

In some cases, the classes of reading errors includes one or more of: addition of words or syllables or letters; omission of words or syllables or letters; miscue of words or syllables or letters; a pause before reading words or syllables or letters; repetition of words or syllables or letters; mispronunciation of words or syllables or letters.

In some cases, the method further comprises determining, based on the user reading profile, a recommendation for one or more subsequent contents to read, out of a plurality of available contents.

In some cases, the processor is part of a user device operated by the user.

In some cases, the processor is external to a user device operated by the user.

In some cases, at least one element of the elements is a visual representation indicative of a meaning of a word.

In some cases, at least one element of the elements is a textual element.

In some cases, the content is a textual content and wherein the elements are textual.

In some cases, the manipulations are visual manipulations.

In some cases, the manipulations and the second manipulations are visual manipulations.

In accordance with a third aspect of the presently disclosed subject matter there is provided a system for providing reading-related feedback, the system comprising a processor configured to: obtain one or more reading-related inputs relating to reading, by a user, of content displayed to the user, the content comprising at least one element, and the reading-related inputs obtained during reading of the content by the user; compare the received reading-related inputs to corresponding expected values for identifying one or more reading-related insights; and provide feedback to the user when identifying one or more reading related-insights.

In some cases, the reading-related insights include one or more error-related insights related to reading errors.

In some cases, the feedback includes one or more of: providing a notification to the user; requesting the user to re-read the element associated with the reading error; changing size of at least part of one or more elements of the content; changing the font style of at least part of one or more elements of the content; changing the font family of at least part of one or more elements of the content; changing the font color of at least part of one or more elements of the content; changing the case of at least part of one or more elements of the content; highlighting at least part of one or more elements of the content; replacing one or more elements of the content with an image; playing a correct pronunciation of at least part of one or more elements via a speaker; changing the space between the elements or parts thereof; changing the font density of at least part of one or more elements of the content; Establishing an interaction between the user and an authorized user.

In some cases, the image is indicative of a meaning of the element.

In some cases, the image is one of the following: an icon; an animated gif; a hyperlink.

In some cases, the feedback is provided in real time.

In some cases, the reading-related inputs are obtained using one or more sensors of a user device operated by the user.

In some cases, the sensors include one or more of the following: a touch sensor; a microphone; a pressure sensor; a camera; a Galvanic Skin Response (GSR) sensor; a heart rate sensor; a pulse sensor.

In some cases, the reading-related inputs include an indication of a current reading position obtained utilizing the touch sensor and wherein the corresponding expected value is an expected current reading position.

In some cases, the reading related-inputs include a voice-to-text value of an audio recording of the user's voice reading a given element of the elements, the audio recording obtained utilizing the microphone, and wherein the corresponding expected value is an expected text.

In some cases, the voice-to-text value is obtained automatically using an automatic voice-to-text converter.

In some cases, the reading-related inputs include an indication of a current applied pressure obtained utilizing the pressure sensor and wherein the corresponding expected value is an expected current applied pressure.

In some cases, the reading-related inputs include a value indicative of a current mental status obtained by automatically analyzing an image of the user's face, the image obtained utilizing the camera, and wherein the corresponding expected value is indicative of an expected current mental status.

In some cases, the processor is part of a user device operated by the user.

In some cases, the processor is external to a user device operated by the user.

In some cases, at least one element of the elements is a visual representation indicative of a meaning of a word.

In some cases, at least one element of the elements is a textual element.

In some cases, the content is a textual content and wherein the elements are textual.

In accordance with a fourth aspect of the presently disclosed subject matter there is provided a method of providing reading-related feedback, the method comprising: obtaining one or more reading-related inputs relating to reading, by a user, of content displayed to the user, the content comprising at least one element, and the reading-related inputs obtained during reading of the content by the user; comparing, by a processor, the received reading-related inputs to corresponding expected values for identifying one or more reading-related insights; and providing feedback to the user when identifying one or more reading related-insights.

In some cases, the reading-related insights include one or more error-related insights related to reading errors.

In some cases, the feedback includes one or more of: providing a notification to the user; requesting the user to re-read the element associated with the reading error; changing size of at least part of one or more elements of the content; changing the font style of at least part of one or more elements of the content; changing the font family of at least part of one or more elements of the content; changing the font color of at least part of one or more elements of the content; changing the case of at least part of one or more elements of the content; highlighting at least part of one or more elements of the content; replacing one or more elements of the content with an image; playing a correct pronunciation of at least part of one or more elements via a speaker; changing the space between the elements or parts thereof; changing the font density of at least part of one or more elements of the content; establishing an interaction between the user and an authorized user.

In some cases, the image is indicative of a meaning of the element.

In some cases, the image is one of the following: an icon; an animated gif; a hyperlink.

In some cases, the feedback is provided in real time.

In some cases, the reading-related inputs are obtained using one or more sensors of a user device operated by the user.

In some cases, the sensors include one or more of the following: a touch sensor; a microphone; a pressure sensor; a camera; a Galvanic Skin Response (GSR) sensor; a heart rate sensor; a pulse sensor.

In some cases, the reading-related inputs include an indication of a current reading position obtained utilizing the touch sensor and wherein the corresponding expected value is an expected current reading position.

In some cases, the reading related-inputs include a voice-to-text value of an audio recording of the user's voice reading a given element of the elements, the audio recording obtained utilizing the microphone, and wherein the corresponding expected value is an expected text.

In some cases, the voice-to-text value is obtained automatically using an automatic voice-to-text converter.

In some cases, the reading-related inputs include an indication of a current applied pressure obtained utilizing the pressure sensor and wherein the corresponding expected value is an expected current applied pressure.

In some cases, the reading-related inputs include a value indicative of a current mental status obtained by automatically analyzing an image of the user's face, the image obtained utilizing the camera, and wherein the corresponding expected value is indicative of an expected current mental status.

In some cases, the processor is part of a user device operated by the user.

In some cases, the processor is external to a user device operated by the user.

In some cases, at least one element of the elements is a visual representation indicative of a meaning of a word.

In some cases, at least one element of the elements is a textual element.

In some cases, the content is a textual content and wherein the elements are textual.

In accordance with a fifth aspect of the presently disclosed subject matter there is provided a non-transitory computer readable storage medium having computer readable program code embodied therewith, the computer readable program code, executable by at least one processor of a computer to perform a method comprising: obtaining one or more reading-related inputs relating to reading, by a user, of content displayed to the user, the content comprising at least one element, and the reading-related inputs obtained during reading of the content by the user; comparing, by a processor, the received reading-related inputs to corresponding expected values for identifying one or more reading errors; and providing feedback to the user when identifying one or more reading errors.

In accordance with a sixth aspect of the presently disclosed subject matter there is provided a non-transitory computer readable storage medium having computer readable program code embodied therewith, the computer readable program code, executable by at least one processor of a computer to perform a method comprising: obtaining one or more reading-related inputs relating to reading, by a user, of content displayed to the user, the content comprising one or more elements, and the reading-related inputs obtained during reading of the content by the user; comparing, by a processor, the received reading-related inputs to corresponding expected values for identifying one or more reading-related insights; and creating a user reading profile, utilizing the reading-related insights.

In accordance with a seventh aspect of the presently disclosed subject matter there is provided a system for creating a user reading profile, the system comprising a processor configured to: obtain one or more reading-related inputs relating to reading, by a user, of a text displayed to the user, the text comprising at least one word, and the reading-related parameters obtained during reading of the text by the user; compare the received reading-related inputs to corresponding expected values for identifying one or more reading errors associated with corresponding words of the text; classify the reading errors according to one or more reading error classes; and create a user reading profile, utilizing the classified reading errors, the user reading profile indicative of a likelihood of the user performing each class of the classes of reading errors.

In accordance with an eighth aspect of the presently disclosed subject matter there is provided a method of creating a user reading profile, the method comprising: obtaining one or more reading-related inputs relating to reading, by a user, of a text displayed to the user, the text comprising at least one word, and the reading-related parameters obtained during reading of the text by the user; comparing, by a processor, the received reading-related inputs to corresponding expected values for identifying one or more reading errors associated with corresponding words of the text; classifying the reading errors according to one or more reading error classes; and creating a user reading profile, utilizing the classified reading errors, the user reading profile indicative of a likelihood of the user performing each class of the classes of reading errors.

In accordance with a ninth aspect of the presently disclosed subject matter there is provided a non-transitory computer readable storage medium having computer readable program code embodied therewith, the computer readable program code, executable by at least one processor of a computer to perform a method comprising: obtaining one or more reading-related inputs relating to reading, by a user, of a text displayed to the user, the text comprising at least one word, and the reading-related parameters obtained during reading of the text by the user; comparing, by a processor, the received reading-related inputs to corresponding expected values for identifying one or more reading errors associated with corresponding words of the text; classifying the reading errors according to one or more reading error classes; and creating a user reading profile, utilizing the classified reading errors, the user reading profile indicative of a likelihood of the user performing each class of the classes of reading errors.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is a system environment diagram schematically illustrating one example of an environment of a system for automatic personalization of digital content, in accordance with the presently disclosed subject matter;

FIG. 2 is a block diagram illustrating one example of a user device, in accordance with the presently disclosed subject matter;

FIG. 3 is a flowchart illustrating one example of a sequence of operations carried out for creating a user reading profile, in accordance with the presently disclosed subject matter;

FIG. 4 is a flowchart illustrating one example of a sequence of operations carried out for presenting personalized manipulated content, in accordance with the presently disclosed subject matter;

FIG. 5 is a flowchart illustrating one example of a sequence of operations carried out for determining, for a given content, a first set of visual manipulations for a first user and a different second set of visual manipulations for a second user, in accordance with the presently disclosed subject matter;

FIG. 6 is a flowchart illustrating one example of a sequence of operations carried out for providing feedback to a reading user, in accordance with the presently disclosed subject matter;

FIG. 7 is a flowchart illustrating one example of a sequence of operations carried out for determining user-specific content recommendation, in accordance with the presently disclosed subject matter;

FIG. 8 is a flowchart illustrating one example of a sequence of operations carried out for identifying reading position related reading insights, in accordance with the presently disclosed subject matter;

FIG. 9 is a flowchart illustrating one example of a sequence of operations carried out for identifying voice-to-text related reading insights, in accordance with the presently disclosed subject matter;

FIG. 10 is a flowchart illustrating one example of a sequence of operations carried out for identifying pressure related reading insights, in accordance with the presently disclosed subject matter;

FIG. 11 is a flowchart illustrating one example of a sequence of operations carried out for mental status related reading insights, in accordance with the presently disclosed subject matter;

FIG. 12a is an exemplary display of non-manipulated content, in accordance with the presently disclosed subject matter;

FIG. 12b is an exemplary display of a manipulated content, in accordance with the presently disclosed subject matter; and

FIG. 12c is another exemplary display of a manipulated content, in accordance with the presently disclosed subject matter.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, and components have not been described in detail so as not to obscure the presently disclosed subject matter.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “obtaining”, “comparing”, “creating”, “determining”, “changing”, “highlighting”, “replacing”, “providing”, “requesting”, “playing”, “establishing” or the like, include action and/or processes of a computer that manipulate and/or transform data into other data, said data represented as physical quantities, e.g. such as electronic quantities, and/or said data representing the physical objects. The terms “computer”, “processor” and “controller” should be expansively construed to cover any kind of electronic device with data processing capabilities, including, by way of non-limiting example, a personal desktop/laptop computer, a server, a computing system, a communication device, a smartphone, a tablet computer, a smart television, a processor (e.g. digital signal processor (DSP), a microcontroller, a field programmable gate array (FPGA), an application specific integrated circuit (ASIC), etc.), any other electronic computing device, and/or any combination thereof.

The operations in accordance with the teachings herein may be performed by a computer specially constructed for the desired purposes or by a general purpose computer specially configured for the desired purpose by a computer program stored in a non-transitory computer readable storage medium. The term “non-transitory” is used herein to exclude transitory, propagating signals, but to otherwise include any volatile or non-volatile computer memory technology suitable to the application.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

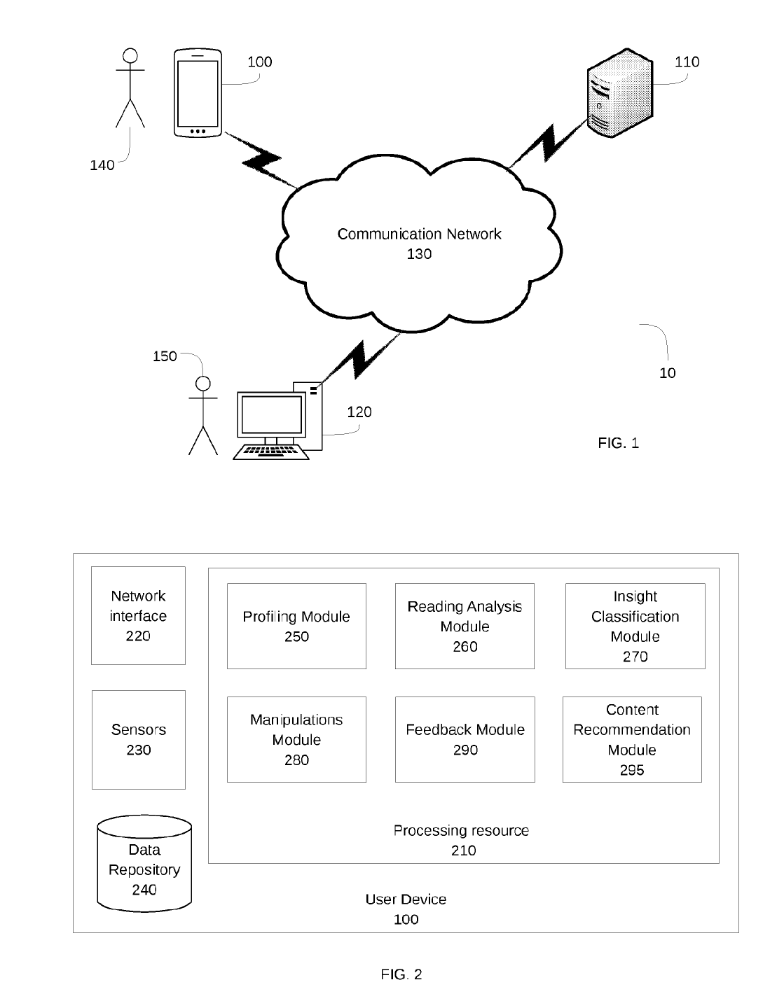

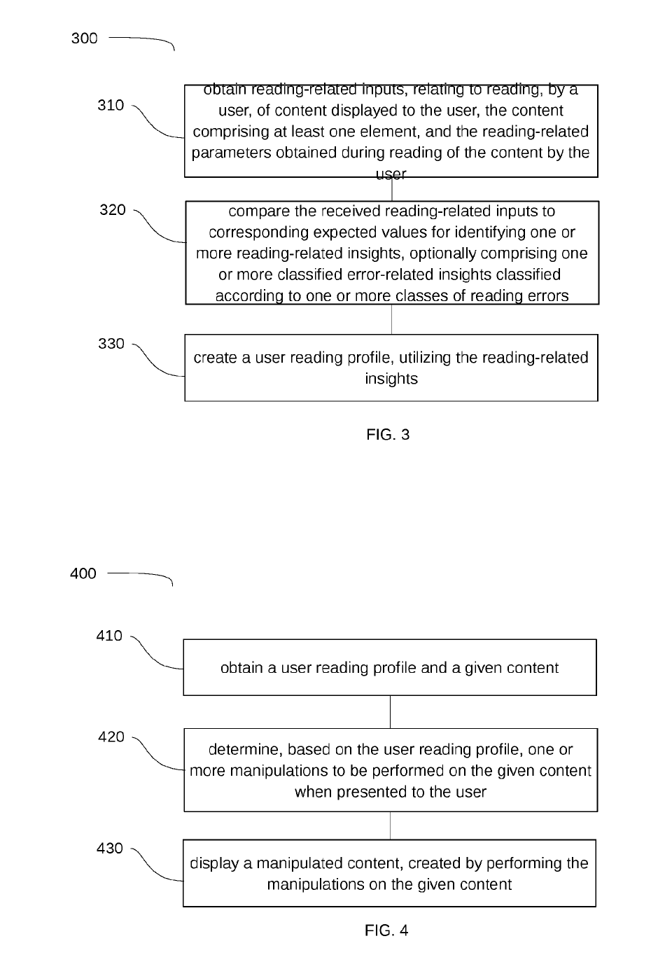

In embodiments of the presently disclosed subject matter, fewer, more and/or different stages than those shown in FIGS. 3-11 may be executed. In embodiments of the presently disclosed subject matter one or more stages illustrated in FIGS. 3-11 may be executed in a different order and/or one or more groups of stages may be executed simultaneously. FIGS. 1 and 2 illustrate a general schematic of the system architecture in accordance with an embodiment of the presently disclosed subject matter. Each module in FIGS. 1 and 2 can be made up of any combination of software, hardware and/or firmware that performs the functions as defined and explained herein. The modules in FIGS. 1 and 2 may be centralized in one location or dispersed over more than one location. In other embodiments of the presently disclosed subject matter, the system may comprise fewer, more, and/or different modules than those shown in FIGS. 1 and 2.

Bearing this in mind, attention is drawn to FIG. 1, showing a system environment diagram schematically illustrating one example of an environment of a system for automatic personalization of digital content, in accordance with the presently disclosed subject matter.

According to certain examples of the presently disclosed subject matter, system 10 comprises one or more user devices 100, each being operable by a corresponding user 140. In some cases, the user device 100 can be a smartphone, a tablet computer, a laptop computer, a desktop computer, a server, a smart televisions, or any other computerized devices suitable for displaying content to users (e.g. on a display, utilizing a projector, or in any other manner), as further detailed herein, inter alia with respect to FIG. 2.

In some cases, the system 10 in its entirety can operate on the user device 100, however, in some cases, additionally or alternatively, all or part of the system's 10 processing can be performed by one or more servers 110 operably connectable to the user devices 100 via a communication network 130 (e.g. the Internet, and/or any other type of communication network, including one or more local area networks), as further detailed herein, inter alia with respect to FIG. 2.

Optionally, the system 10 can further comprise one or more authorized user devices 120, each being operable by a corresponding authorized user 150 (e.g. a physician, a teacher of the user 140, a parent of the user 140, a content provider, etc.) authorized to receive various information about the performance of users 140 (using the system 10) that such authorized user 150 is authorized to receive (e.g. in accordance with a certain authorization policy), and/or to configure various parameters relating to the interaction of the system 10 and the corresponding user 140 (e.g. changing the difficulty level, providing manual recommendations for content, etc.), and/or to provide feedback to the users 140 based on information received from the system 10. In some cases, the authorized user device 120 can be a smartphone, a tablet computer, a laptop computer, a desktop computer, a server, a smart televisions, or any other computerized device. The authorized user devices 120 can be operably connected to the user devices 100 and/or to the servers 110 via the communication network 130.

Turning to FIG. 2, there is shown a block diagram illustrating one example of a user device, in accordance with the presently disclosed subject matter.

According to certain examples of the presently disclosed subject matter, user device 100 can comprise one or more network interfaces 220 enabling connecting the user device 100 to one or more communication networks and enabling it to send and receive data sent thereto through such communication networks, including sending and/or receiving data to/from the servers 110 and/or the authorized user devices 120.

User device further comprises or be otherwise associated with, one or more sensors 230 configured to obtain one or more reading-related inputs relating to reading, by the user 140, of content displayed to the user 140 by the user device 100. In some cases, the sensors can include one or more of a touch screen (including a force sensitive touch screen), a microphone, a pressure sensor, a camera, a Galvanic Skin Response (GSR) sensor, a heart rate sensor, a pulse sensor, etc. It is to be noted that the sensors 230 can be part of the user device 100, or otherwise connected thereto (using any type of connection, including a wired and/or a wireless connection).

User device 100 can further comprise, or be otherwise associated with, a data repository 240 (e.g. a database, a storage system, a memory including Read Only Memory—ROM, Random Access Memory—RAM, or any other type of memory, etc.) configured to store data, including inter alia data relating to available contents, data relating to interactions of the user 140 with the system 10, etc., as further detailed herein. In some cases, data repository 240 can be further configured to enable retrieval and/or update and/or deletion of the stored data.

It is to be noted that in some cases, data repository 240 can be distributed between the user device 100 and the servers 110 and/or authorized user devices 120. In other cases, the data repository 240 can be fully located remotely from the user device 100, and in such cases, the user device 100 can be operably connected thereto (e.g. via a communication network 130), or otherwise associated therewith.

User device 100 further comprises one or more processing resources 210. Processing resource 210 can be one or more processing units (e.g. central processing units), microprocessors, microcontrollers or any other computing devices or modules, including multiple and/or parallel and/or distributed processing units, which are adapted to independently or cooperatively process data for controlling relevant system resources and for enabling operations related to system resources.

The processing resource 210 can comprise one or more of the following modules: profiling module 250, reading analysis module 260, insight classification module 270, manipulations module 280, feedback module 290 and content recommendation module 295.

According to some examples of the presently disclosed subject matter, profiling module 250 can be configured to create a user reading profile, as further detailed herein, inter alia with respect to FIG. 3.

According to some examples of the presently disclosed subject matter, reading analysis module 260 can be configured to analyze reading-related inputs for identifying one or more reading-related insights, as further detailed herein, inter alia with respect to FIGS. 3, and 8-11.

According to some examples of the presently disclosed subject matter, insight classification module 270 can be configured to classify error-related insights according to one or more classes of reading errors, as further detailed herein, inter alia with respect to FIG. 3.

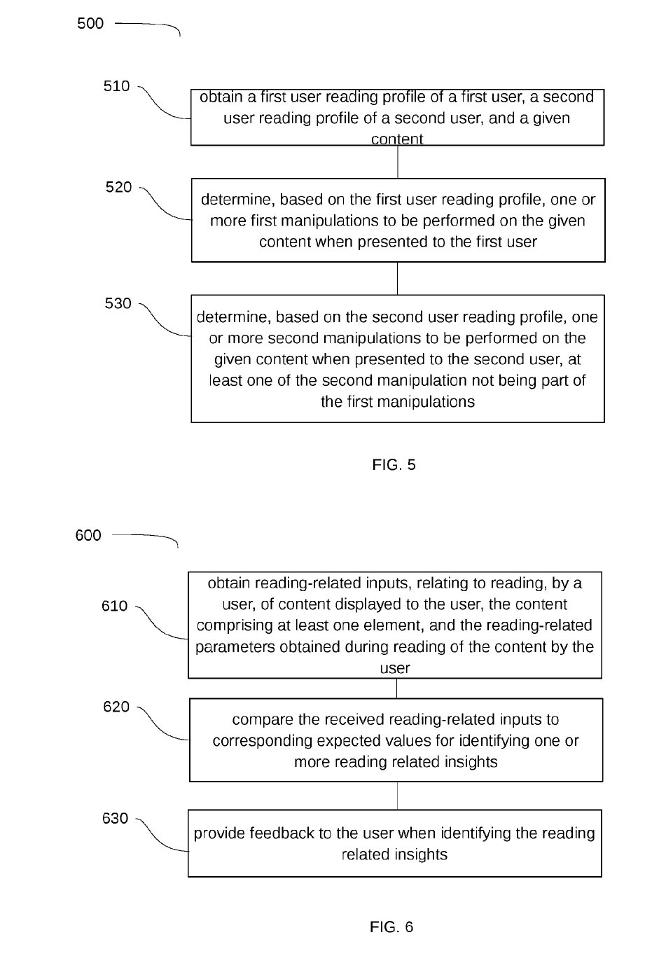

According to some examples of the presently disclosed subject matter, manipulations module 280 can be configured to determine, based on a user reading profile, one or more manipulations (e.g. visual manipulations, manipulations resulting in triggering events, such as providing haptic feedback and/or playing a certain sound and/or playing a certain movie at a certain point in time of reading the content by the user 140, etc.) to be performed on content when presented to the user 140, as further detailed herein, inter alia with respect to FIGS. 4 and 5.

According to some examples of the presently disclosed subject matter, feedback module 290 can be configured to provide feedback to the user 140, as further detailed herein, inter alia with respect to FIG. 6.

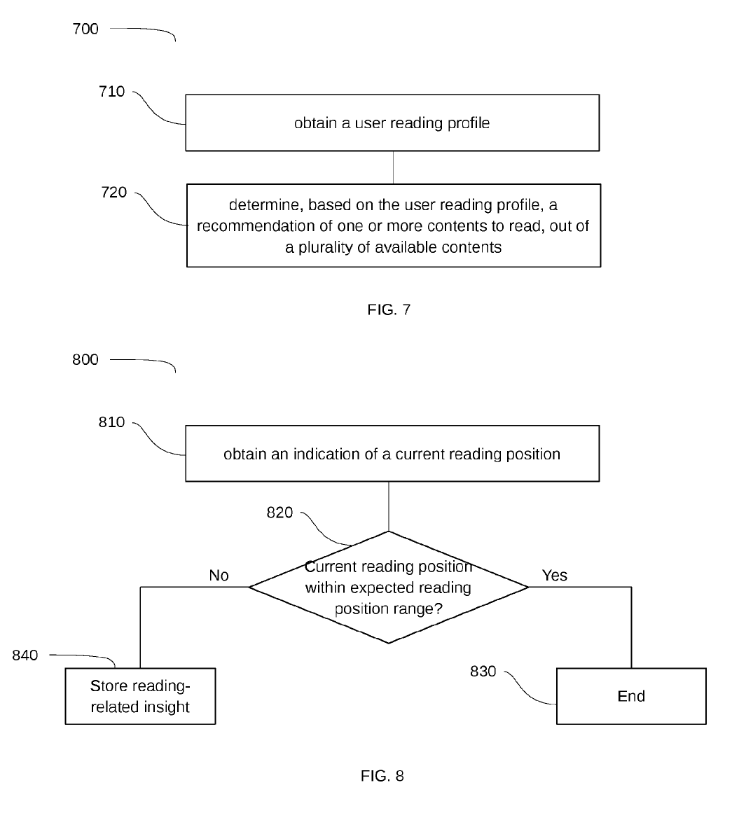

According to some examples of the presently disclosed subject matter, content recommendation module 295 can be configured to determine, based on the user reading profile, a recommendation of one or more contents to read, out of a plurality of available contents, as further detailed herein, inter alia with respect to FIG. 7.

It is to be noted that in some cases all or part of the modules can be distributed between processing resources of the user device 100 and/or the servers 110 and/or authorized user devices 120. In other cases, the modules can be fully comprised within a processing resource external to the user device 100 (e.g. one or more processing resources of the servers 110 and/or one or more processors of the authorized user devices 120) and in such cases, the user device 100 can be operably connected thereto (e.g. via a communication network 130), or otherwise associated therewith. When reference is made in the foregoing description to system 10 in the context of performing any of the processes described therein (or parts of such processes), it should be understood that any computerized component of the system 10 (e.g. user device 100, servers 110, authorized user devices 120) or any combination of two or more components of the system 10 can perform the corresponding processing, mutatis mutandis.

Having described the system architecture, attention is drawn to FIG. 3, showing a flowchart illustrating one example of a sequence of operations carried out for creating a user reading profile, in accordance with the presently disclosed subject matter.

According to some examples of the presently disclosed subject matter, system 10 can be configure to perform a user reading profile creation process 300, e.g. utilizing the profiling module 250.

For that purpose, system 10 can be configured to obtain (e.g. in real-time and/or by retrieval from the data repository 240, etc.) one or more reading-related inputs relating to reading, by a user 140, of content displayed to the user 140, the content comprising one or more elements, and the reading-related inputs obtained during reading of the content by the user 140 (block 310).

The content can be displayed to the user 140 by the user device 100, e.g. utilizing a display of the user device 100, or by any other manner (e.g. projecting the content on a surface external to the user device 100, e.g. utilizing a projector, etc.). In some cases, the content displayed to the user is a textual content comprising textual elements (e.g. words). In other cases, the content can be a mixed content comprising both textual and non-textual elements (e.g. visual representation indicative of a meaning of a word, pictures, symbols, hypertext links, sounds, scents, etc.). In still further cases, the content can be non-textual comprising non-textual elements only.

The reading-related inputs can be a combination of one or more inputs obtained using one or more sensors 230 during reading of the content by the user 140.

Several non-limiting examples of reading-related input types are disclosed herein for clarity:
(a) In some cases, the users 140 can be instructed to continuously move their finger over the element (e.g. a word, etc.) that they are reading in real-time, and in some cases, over the specific part of the element (e.g. a specific letter of a word, etc.) that they are reading in real-time. In such cases, the reading-related inputs can include, inter alia, values indicative of the positions of the user's 140 finger at corresponding times (e.g. with respect to the time the user 140 began reading the content) as the reading takes place. Such values can be obtained by a touch sensor of a touch screen (or any other type of sensor that enables determining values indicative of the positions of the user's 140 finger at corresponding times) of the user device 100.
(b) In some cases, the reading-related inputs can include a voice-to-text value of the corresponding content's elements that are read out loud by the user 140. It is to be noted that the conversion of the voice to text can be performed manually or automatically (e.g. using known methods and techniques, e.g. voice-to-text algorithms). The user's voice when reading the content can be obtained by a microphone of the user device 100. In some cases, voice recognition can be performed by the system 10 for identifying the specific user 140 that is reading the content.
(c) In some cases, the reading-related inputs can include values indicative of an amount of pressure the user's 140 finger is applying on the user device 100 at a given time (e.g. as he is moving his finger over the content's elements that he is reading in real time). The indication can be obtained by a pressure sensor of the user device 100.
(d) In some cases, the reading-related inputs can include values indicative of an mental status of the user 140 at given times during the reading. The values can be obtained by analyzing one or more images of the user's 140 face and/or other body parts, obtained during reading the content by the user 140. The analysis of the images can be manual or automatic (e.g. using known methods and techniques).
(e) In some cases, the reading-related inputs can include one or more values indicative of the time (e.g. in seconds/milliseconds) it took the user 140 to read the content and/or specific parts thereof. The values can be obtained using a timer, e.g. of the user device 100, that is triggered when the system 10 identifies that the user 140 starts to read the corresponding section of the content and stopped when the system 10 identifies that the user finished reading the corresponding section of the content (e.g. using inputs from the user device's microphone and/or touch sensor and/or other sensors that can enable determining the time the user 140 starts to read the corresponding section of the content and the time the user 140 finishes reading the corresponding section of the content).
(f) In some cases, the reading-related inputs can include a recording of the user's reading of the content out loud. The user's voice when reading the content can be obtained by a microphone of the user device 100.
(g) In some cases, the reading-related inputs can include a value indicative of the specific part of the element (e.g. a specific letter of a word, etc.) that the user 140 is reading in real-time, that is obtained by analysis of an image of the user's 140 eye obtained for example utilizing a camera.

In some cases the system 10 can be further configured to compare the received reading-related inputs to corresponding expected values for identifying one or more reading-related insights, e.g. utilizing reading analysis module 260 (block 320).

Looking at the same reading-related inputs provided as examples herein above, the corresponding expected values can be, for example:
(a) An expected reading position, indicative of an expected reading position at a corresponding time (e.g. with respect to the time the user 140 began reading the content). It is to be noted that in some cases, the expected reading position can define a range of positions, as a certain sliding window that can be allowed between the current reading position and the expected reading position (which can be a given position). The expected reading position and/or the expected reading position range can be user-specific, as, for example, a more experienced user is expected to read faster than a less experienced user, if the content is presented to the user 140 in his native tongue, he is expected to read faster than if the content is presented in a non-native tongue of the user 140, etc. In addition, the expected reading position and/or the expected reading position range can be content-specific, as, for example, a more complicated content is read slower than a less complicated content (for a given level of accuracy, as in some cases, more complicated text can be read faster than less complicated content, but with more errors), etc. Still further, the expected reading position and/or the expected reading position range can be visual-presentation-specific, as, for example, content presented in a denser manner is expected to be read slower than content presented in a less dense manner.
(b) An expected word associated with a corresponding content element.
(c) An expected amount of pressure the specific user's 140 finger is expected to apply on the user device 100 at a given time. It is to be noted that the expected amount of pressure can be user-specific, as different users can apply different pressure on a pressure sensor, even in identical situations. It is to be noted that in some cases the system 10 can be configured to monitor the pressure levels that the specific user 140 is applying and calculate a reference value (or range) representing a normal pressure level that does not indicate of unusual stress or unusual mental status for the specific user 140.
(d) An expected mental status of the user 140 at given times during the reading. For example, the user 140 can be expected to be relaxed when reading a certain part of the content and anxious when reading another part of the content. A mismatch can indicate that the user 140 does not understand the content or parts thereof.
(e) An expected time (e.g. in seconds/milliseconds) for reading the content or a specific part thereof (e.g. one or more elements of the content). The expected time can be user-specific, as, for example, a more experienced user is expected to read faster than a less experienced user, if the content is presented to the user 140 in his native tongue, he is expected to read faster than if the content is presented in a non-native tongue of the user 140, etc. In addition, the expected time can be content-specific, as, for example, a more complicated content is read slower than a less complicated content (for a given level of accuracy, as in some cases, more complicated text can be read faster than less complicated content, but with more errors), etc. Still further, the expected time can be visual-presentation-specific, as, for example, content presented in a denser manner is expected to be read slower than content presented in a less dense manner.
(f) An expected signal representing the sounds that are expected to be heard when reading the content.

As indicated herein, the system 10 compares the received reading-related inputs to the corresponding expected values, for identifying reading-related insights.

In some cases, one or more of the reading-related insights can be insights that relate to errors made by the user when reading the content (hereinafter: “error-related insights”). Some non-limiting examples of classes of errors can include:
(a) Addition of one or more words and/or syllables and/or letters to the content or to certain elements thereof. Such error can be identified for example by comparing a voice-to-text value of the read elements with the expected words.
(b) Omission of one or more words and/or syllables and/or letters from the content or certain elements thereof. Such error can be identified for example by comparing a voice-to-text value of the read elements with the expected words.
(c) Miscue of one or more words and/or syllables and/or letters of the content or certain elements thereof. Such error can be identified for example by comparing a voice-to-text value of the read elements with the expected words.
(d) A pause before reading one or more words and/or syllables and/or letters of the content or certain elements thereof. Such error can be identified for example by comparing a real-time reading position with the expected reading position.
(e) Repetition of one or more words and/or syllables and/or letters of the content or certain elements thereof. Such error can be identified for example by comparing a voice-to-text value of the read elements with the expected words.
(f) Mispronunciation of one or more words and/or syllables and/or letters of the content or certain elements thereof. Such error can be identified for example by comparing a voice-to-text value of the read elements with the expected words.

In some cases, such error-related insights can be classified according to one or more classes of reading errors (e.g. all or part of the exemplary classes detailed above and/or other classes of errors), e.g. utilizing the insight classification module 270.

In some cases, one or more of the reading-related insights can be insights that do not relate to errors made by the user (hereinafter: “non-error-related insights”). Some non-limiting examples of non-error-related-insights can include:
(a) The length of time of reading the content by the user 140 exceeds a threshold, thus indicating that it took the user 140 too much time to read the content. It is to be noted that the threshold can be user-specific, so that a first user can be expected to read the text within X seconds and a second user can be expected to read the text within Y seconds, where X≠Y. It is to be further noted that the threshold can be dynamic, as it can be dependent on a time of day, a complexity of the content, etc., so that, for example, during the night hours the user 140 can be expected to read the text within X1 seconds and during day time the user can be expected to read the text within Y1 seconds, where X1≠Y1.
(b) The pressure applied by the user's 140 finger exceeds a threshold, thus indicating that reading of a certain element or part thereof (e.g. a word or a syllable) was harder for the user 140 than reading other elements.
(c) The mental status of the user 140 does not match an expected mental status of the user 140, thus indicating that reading of a certain element or part thereof (e.g. a word or a syllable) was harder for the user 140 than reading other elements.
(d) A grade can be calculated for a rhythm of reading the content by comparing the expected signal representing the sounds that are expected to be heard when reading the content to a recording of the reading of the content by the user 140.

In some cases, one or more of the insights can be determined by a combination of two or more received reading-related inputs to the corresponding expected values (e.g. if the user is reading slower than expected and applying a higher level of pressure on the touch screen then expected, then an insight can be determined. In some cases, one or more of the insights can be determined without comparison of the reading-related inputs to corresponding expected values (for example, analysis of the facial expressions of the user 140, can enable determining a level of satisfaction/frustration/etc. of the user 140 while reading).

In some cases, the reading-related insights can be stored on data repository 240. In some cases, reading-related insights can be collected from reading of a plurality of different contents provided to the user over a certain period of time, and/or reading a given content several times over a certain time period of time.

Utilizing the reading-related insights, or parts thereof, the system 10 can be configured to create a user reading profile, e.g. utilizing the profiling module 250 (block 330). In some cases, the user reading profile is indicative of a reading proficiency of the user 140. In some cases, the user reading profile is indicative of a likelihood of the user 140 performing each class of the classes of reading errors. In some cases, the number of errors of each class can be calculated (e.g. summed) and compared to a certain threshold for calculating the likelihood of the user 140 performing each class of the classes of reading errors. In some cases the threshold for one or more of the classes of errors can be dynamic. For example, the threshold can be age-dependent, sex-dependent, language-dependent, etc. In some cases, the thresholds can be determined also utilizing input received from an authorized user 150 (e.g. physician/teacher/patent/etc.). In some cases the thresholds can be manually determined, e.g. by an authorized user 150 (e.g. physician/teacher/patent/etc.).

It is to be noted that the system 10 can continuously update the user reading profile utilizing reading-related insights obtained during reading of additional subsequent content provided to the user. In some cases, the system 10 can utilize reading-related insights obtained during a certain time period (e.g. the past week, the past month, the past year, etc.).

It is to be further noted, with reference to FIG. 3, that some of the blocks can be integrated into a consolidated block or can be broken down to a few blocks and/or other blocks may be added. It should be also noted that whilst the flow diagram is described also with reference to the system elements that realizes them, this is by no means binding, and the blocks can be performed by elements other than those described herein.

Attention is now drawn to FIG. 4 showing a flowchart illustrating one example of a sequence of operations carried out for presenting personalized manipulated content, in accordance with the presently disclosed subject matter.

According to some examples of the presently disclosed subject matter, system 10 can be configure to perform a manipulations determination process 400, e.g. utilizing the manipulations module 280.

For that purpose, system 10 can be configured to obtain (e.g. in real-time and/or by retrieval from the data repository 240, etc.) a user reading profile of a given user 140 and a given content (block 410).

In some cases, the system 10 can be further configured to determine, based on the user reading profile of the given user 140, one or more manipulations to be performed on the given content when presented to the user (block 420). In some cases, the manipulations can reduce the likelihood of the given user 140 performing reading errors when reading the given content.

As indicated above, the user reading profile can include an indication of the likelihood of the user 140 performing each class of the classes of reading errors detailed herein. Therefore, having knowledge of such likelihood, various personalized manipulations can be performed on the content so as to reduce the likelihood of the user 140 performing errors of certain classes. Assuming for example that a user's 140 likelihood of performing an error of a given class is above a certain threshold (e.g. above 50% likelihood), the system 10 can determine one or more manipulations on the given text that reduce the likelihood of the user 140 to perform errors of such class. For example, assuming that the user's 140 reading profile indicates that the user 140 has a high likelihood of omitting some syllables within certain words—the system 10 can be configured to manipulate such words by highlighting such syllables. As another example, assuming that the user's 140 reading profile indicates that the user has a high likelihood of substituting certain syllables with other syllables, the system 10 can be configured to increase the space between the letters of words comprising such syllables, etc.

The system 10 can perform various types of manipulations, including, as non-limiting examples:
(a) changing size of at least part of one or more elements of the given content;
(b) changing the font style of at least part of one or more elements of the given content;
(c) changing the font family of at least part of one or more elements of the given content;
(d) changing the font color of at least part of one or more elements of the given content;
(e) changing the case of at least part of one or more elements of the given content;
(f) highlighting at least part of one or more elements of the given content;
(g) replacing one or more elements of the given content with an image, that can be an icon, an animated gif, a hyperlink, an image indicative of a meaning of the element;
(h) changing the space between words, syllables or letters;
(i) changing the font density of at least part of one or more elements of the given content;
(j) replacing one or more elements of the given content with a link to play a correct pronunciation of at least part of one or more element via a speaker, etc.

In some cases, the system 10 can be further configured to display (e.g. on a display of the user device 100) a manipulated content, created by performing the manipulations on the given content (block 430).

It is to be noted that the approach of providing users with manipulated content, manipulated according to their user profiles is advantageous from various reasons, as inter alia it provides a reading experience that is better than current reading solutions, it can improve users recollection and comprehension of content consumed thereby, and it can assist people with reading deficiencies. One specific example of an advantage is in the case of Dyslexia, that is characterized by a coding/decoding difficulty and a spatial manipulation difficulty of the person affected. Providing an environment where the focus is directed at the right portion of the content at each time has many advantages for Dyslexic people. Having the knowledge of where the errors is going to happen enables applying various strategies to reduce the effort of the reader while decoding the word.

It is to be noted, with reference to FIG. 4, that some of the blocks can be integrated into a consolidated block or can be broken down to a few blocks and/or other blocks may be added. It is to be further noted that some of the blocks are optional. It should be also noted that whilst the flow diagram is described also with reference to the system elements that realizes them, this is by no means binding, and the blocks can be performed by elements other than those described herein.

Turning to FIG. 5 there is shown a flowchart illustrating one example of a sequence of operations carried out for determining, for a given content, a first set of visual manipulations for a first user and a different second set of visual manipulations for a second user, in accordance with the presently disclosed subject matter.

According to some examples of the presently disclosed subject matter, system 10 can be configure to perform a user-specific manipulations determination process 500, e.g. utilizing the manipulations module 280. As indicated herein, the manipulations determined on block 420 are determined based on a user reading profile. Therefore, when looking at two different users, different manipulations can be determined for each user based on his corresponding user reading profile, as further detailed herein.

According to some examples of the presently disclosed subject matter, the system 10 can be configured to obtain a first user reading profile of a first user, a second user reading profile of a second user, and a given content for the users to read (block 510).

In some cases, the system 10 can be further configured to determine, based on the first user reading profile, one or more manipulations to be performed on the given content when presented to the first user (block 520), and to determine, based on the second user reading profile, one or more manipulations to be performed on the given content when presented to the second user, where at least one of the manipulation determined to be performed on the given content based on the first user reading profile is not determined to be performed on the given content based on the second user account (block 530). This will result in the content being presented to the first user in a first manner and to the second user in a second manner, according to the respective user reading profiles.

It is to be noted that, with reference to FIG. 5, some of the blocks can be integrated into a consolidated block or can be broken down to a few blocks and/or other blocks may be added. Furthermore, in some cases, the blocks can be performed in a different order than described herein (for example, block 530 can be performed before block 520, etc.). It is to be further noted that some of the blocks are optional. It should be also noted that whilst the flow diagram is described also with reference to the system elements that realizes them, this is by no means binding, and the blocks can be performed by elements other than those described herein.

FIG. 6 is a flowchart illustrating one example of a sequence of operations carried out for providing feedback to a reading user, in accordance with the presently disclosed subject matter.

According to some examples of the presently disclosed subject matter, system 10 can be configure to perform a reading feedback process 600, e.g. utilizing the feedback module 290.

For that purpose, system 10 can be configured to obtain in real-time one or more reading-related inputs relating to reading, by a user 140, of content displayed to the user 140, the content comprising one or more elements, and the reading-related inputs obtained during reading of the content by the user 140 (block 610).

The content can be displayed to the user 140 by the user device 100, e.g. utilizing a display of the user device 100, or by any other manner (e.g. projecting the content on a surface external to the user device 100, e.g. utilizing a projector, etc.). In some cases, the content displayed to the user is a textual content comprising textual elements (e.g. words). In other cases, the content can be a mixed content comprising both textual and non-textual elements (e.g. visual representation indicative of a meaning of a word, pictures, symbols, hypertext links, sounds, scents, etc.). In still further cases, the content can be non-textual comprising non-textual elements only.

The reading-related inputs can be a combination of one or more inputs obtained using one or more sensors 230 during reading of the content by the user 140, as detailed with reference to FIG. 3.

In some cases the system 10 can be further configured to compare the received reading-related inputs to corresponding expected values, as detailed with reference to FIG. 3, for identifying one or more reading-related insights, e.g. utilizing reading analysis module 260 (block 620). In some cases, one or more of the reading-related insights can be non-error-related insights. In some cases, one or more of the reading-related insights can be error-related insights. As detailed herein, an error can be, for example:
(a) Addition of one or more words and/or syllables and/or letters to the content or to certain elements thereof. Such error can be identified for example by comparing a voice-to-text value of the read elements with the expected words.
(b) Omission of one or more words and/or syllables and/or letters from the content or certain elements thereof. Such error can be identified for example by comparing a voice-to-text value of the read elements with the expected words.
(c) Miscue of one or more words and/or syllables and/or letters of the content or certain elements thereof. Such error can be identified for example by comparing a voice-to-text value of the read elements with the expected words.
(d) A pause before reading one or more words and/or syllables and/or letters of the content or certain elements thereof. Such error can be identified for example by comparing a real-time reading position with the expected reading position.
(e) Repetition of one or more words and/or syllables and/or letters of the content or certain elements thereof. Such error can be identified for example by comparing a voice-to-text value of the read elements with the expected words.
(f) Mispronunciation of one or more words and/or syllables and/or letters of the content or certain elements thereof. Such error can be identified for example by comparing a voice-to-text value of the read elements with the expected words.

In some cases, the system 10 can be further configured to provide feedback to the user when identifying the reading related insights (block 630). In some cases, the feedback can be provided in real-time (or near real-time). In some cases the feedback can be provided after a certain delay. In some cases the delay can be dynamic (e.g. after the user 140 finishes reading an element of the content, after the user 140 finishes reading of a sentence of the content, after the user 140 finishes reading the content, etc.). In some cases, the feedback can include one or more of the following exemplary feedback types:
(a) Providing an error notification to the user, optionally indicating the error. For example, the system 10 can be configured to display a notification on the user devices' 100 screen and/or to play an error notification utilizing the user devices' 100 speaker and/or to utilize a vibrating element of the user device 100 thus making the user device vibrate when the error is identified, etc.
(b) Requesting the user 140 to re-read the element associated with the reading error. Assuming that the user 140 made an error when reading a certain element, the system 10 can be configured to request the user 140 (e.g. by outputting an appropriate notification to the user 10) to re-read the element, e.g. until the system 10 identifies that the element is read correctly.
(c) Changing size of at least part of one or more elements. For example, the system 10 can be configured to increase the size of the element associated with the error so that it will be easier to read.
(d) Changing the font style of at least part of one or more elements. For example, the system 10 can be configured to change the font style of the element associated with the error so that it will be easier to read.
(e) Changing the font family of at least part of one or more elements. For example, the system 10 can be configured to change the font family of the element associated with the error so that it will be easier to read.
(f) Changing the font color of at least part of one or more elements. For example, the system 10 can be configured to change the font color of the element associated with the error so that it will be easier to read (e.g. change the font color to red or another color).
(g) Changing the case of at least part of one or more elements. For example, the system 10 can be configured to change the case of the element associated with the error so that it will be easier to read (e.g. change the element to uppercase).
(h) Highlighting at least part of one or more elements. For example, the system 10 can be configured to highlight the element associated with the error so that it will be easier to read.
(i) Replacing one or more elements with an image. For example, the system 10 can be configured to replace the element associated with the error with an image indicative of the meaning of the element. For example, if the element is the word “bird”, the element can be replaced with an image of a bird, etc.
(j) Playing a correct pronunciation of at least part of one or more element via a speaker. For example, the system 10 can be configured to play reading of the element as it should be read.
(k) changing the space between elements or parts thereof;
(l) changing the font density of at least part of one or more elements of the given content;
(m) Establishing an interaction between the user and an authorized user. For example, the system 10 can be configured to create an connection between the user device 100 and an authorized user device 120 (operated by an authorized user 150, e.g. a teacher/parent/physician/etc. that are authorized to interact with the user 140) for enabling the user 140 and the authorized user 150 to interact utilizing user device 100 and authorized user device 120.

It is to be noted that, with reference to FIG. 6, some of the blocks can be integrated into a consolidated block or can be broken down to a few blocks and/or other blocks may be added. It should be also noted that whilst the flow diagram is described also with reference to the system elements that realizes them, this is by no means binding, and the blocks can be performed by elements other than those described herein.

Turning to FIG. 7 there is shown a flowchart illustrating one example of a sequence of operations carried out for determining user-specific content recommendation, in accordance with the presently disclosed subject matter.

According to some examples of the presently disclosed subject matter, system 10 can be configure to perform a content recommendation process 700, e.g. utilizing the content recommendation module 295.

For that purpose, system 10 can be configured to obtain a user reading profile (e.g. created by the user reading profile creation process 300, or otherwise obtained) (block 710). As indicated herein, in some cases, the user reading profile is indicative of a reading proficiency of the user 140. In some cases, the user reading profile is indicative of a likelihood of the user 140 performing each class of the classes of reading errors. It is to be noted that in some cases, the user reading profile can comprise additional information collected by the system 10, including, for example, information indicative of reading preferences of the user (e.g. an indication if the user 140 likes to read sports/economics/politics/etc., information of languages the user 140 is reading, etc.).

Utilizing the user reading profile, the system 10 can be configured to determine a recommendation of one or more contents to read, out of a plurality of available contents (block 720). For example, if the user reading profile indicates of a certain reading proficiency level of the user 140 (for example in the form of a reading proficiency grade associated with the user 140), the system 10 can be configured to match content that meets the user's 140 proficiency level (e.g. utilizing an analysis of the contents, complexity grades thereof can be calculated by the system 10 for that purpose). For example (non-limiting), assuming that the user's 140 reading proficiency grade is 60, the system 10 can be configured to recommend content whose complexity grade (that can in some cases be pre-determined or automatically calculated, etc.) is within a range of ±10 points of the user's 140 reading proficiency grade.

It is to be noted that, with reference to FIG. 7, some of the blocks can be integrated into a consolidated block or can be broken down to a few blocks and/or other blocks may be added. It should be also noted that whilst the flow diagram is described also with reference to the system elements that realizes them, this is by no means binding, and the blocks can be performed by elements other than those described herein.

Attention is drawn to FIG. 8 showing a flowchart illustrating one example of a sequence of operations carried out for identifying reading position related reading insights, in accordance with the presently disclosed subject matter.

According to some examples of the presently disclosed subject matter, system 10 can be configure to perform a reading position related reading insights identification process 800, e.g. utilizing the reading analysis module 260.

For that purpose, system 10 can be configured to obtain an indication of a current reading position (block 810). As indicated herein, with reference to FIG. 3, the users 140 can be instructed to continuously move their finger over the element (e.g. a word, etc.) that they are reading in real-time, and in some cases, over the specific part of the element (e.g. a specific letter of a word, etc.) that they are reading in real-time. In such cases, the reading-related inputs can include, inter alia, values indicative of the positions of the user's 140 finger at corresponding times (e.g. with respect to the time the user 140 began reading the content) as the reading takes place. Such values are also referred to herein as “current reading position”. Such values can be obtained by a touch sensor of a touch screen of the user device 100.

In some cases, system 10 can be configured to check if the current reading position is within an expected reading position range (block 820). As indicated herein, with reference to FIG. 3, the expected reading position range is indicative of an expected reading position at a corresponding time (e.g. with respect to the time the user 140 began reading the content). It is to be noted that in some cases, the expected reading position range can define a range of positions as a certain sliding window that can be allowed between the current reading position and an expected reading position (which can be a given position). The expected reading position and/or the expected reading position range can be user-specific, as, for example, a more experienced user is expected to read faster than a less experienced user, if the content is presented to the user 140 in his native tongue, he is expected to read faster than if the content is presented in a non-native tongue of the user 140, etc. In addition, the expected reading position and/or the expected reading position range can be content-specific, as, for example, a more complicated content is read slower than a less complicated content (for a given level of accuracy, as in some cases, more complicated text can be read faster than less complicated content, but with more errors), etc. Still further, the expected reading position and/or the expected reading position range can be visual-presentation-specific, as, for example, content presented in a denser manner is expected to be read slower than content presented in a less dense manner.

If the current reading position is within a range defined by the expected reading position, the process ends (block 830). However, it the current reading position is not within the expected reading position range, the system 10 can be configured to store a reading-related insight in the data repository 240 (block 840), including information of the time and/or location within the content at which the current reading position left the expected reading position range, the difference between the current reading position and one or more of the boundaries set by the expected reading position range, etc. Such reading-related insight can be utilized by the system 10 when creating the user reading profile as detailed herein with reference to FIG. 3.

As a simplistic example, assuming that the user 140 is presented with a sentence “the dog and the cat are very good friends”, and at a certain point in time he is reading a certain part of the word “cat”, whereas, according to the expected reading position range he is expected to read anywhere between the word “very” and “friends”, clearly the user 140 is not reading as fast as expected and a reading-related insight is identified.

It is to be noted that, with reference to FIG. 8, some of the blocks can be integrated into a consolidated block or can be broken down to a few blocks and/or other blocks may be added. It should be also noted that whilst the flow diagram is described also with reference to the system elements that realizes them, this is by no means binding, and the blocks can be performed by elements other than those described herein.

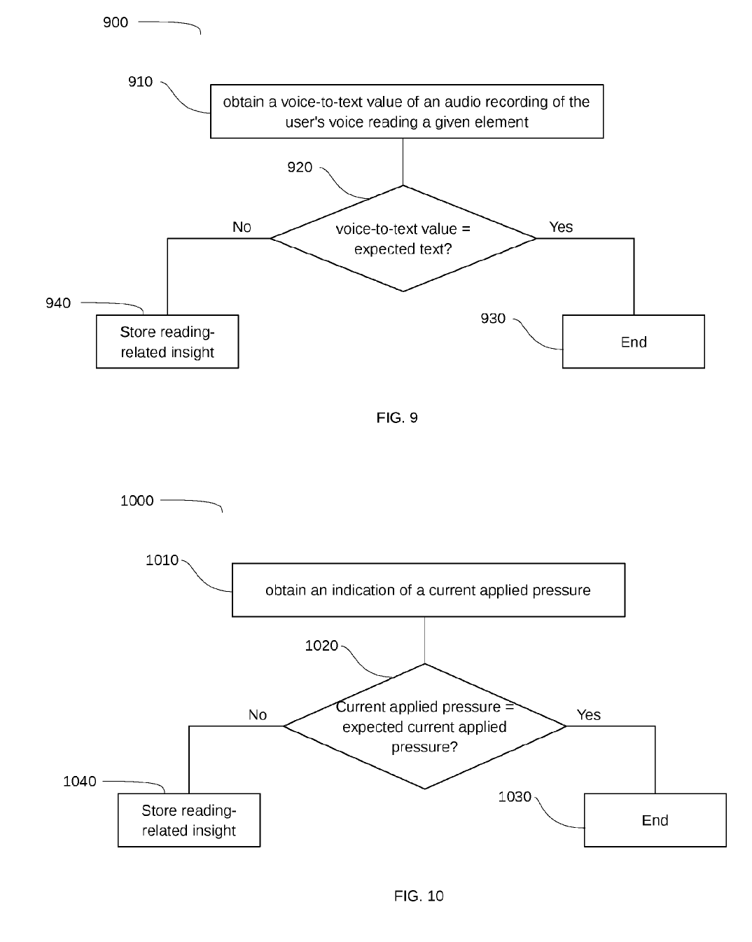

FIG. 9 is a flowchart illustrating one example of a sequence of operations carried out for identifying voice-to-text related reading insights, in accordance with the presently disclosed subject matter.

According to some examples of the presently disclosed subject matter, system 10 can be configure to perform a voice-to-text related reading insights identification process 900, e.g. utilizing the reading analysis module 260.

For that purpose, system 10 can be configured to obtain a voice-to-text value of an audio recording of the user's voice reading a given element (block 910). It is to be noted that the conversion of the voice to text can be performed manually or automatically (e.g. using known methods and techniques, e.g. voice-to-text algorithms). The user's voice when reading the content can be obtained by a microphone of the user device 100.

In some cases, system 10 can be configured to check if the obtained voice-to-text value is equal to the expected text the user is expected to read (e.g. by comparing the voice-to-text value to the corresponding element of the content) (block 920).

If so—the process ends (block 930), however, if the obtained voice-to-text value is not equal to the expected text the user is expected to read, the system 10 can be configured to store a reading-related insight in the data repository 240 (block 940), including information of the voice-to-text value, the expected text the user is expected to read, the context (e.g. the sentence comprising the expected text presented to the user), etc. Such reading-related insight can be utilized by the system 10 when creating the user reading profile as detailed herein with reference to FIG. 3.

Looking again at the simplistic example where the user 140 is presented with a sentence “the dog and the cat are very good friends”, and the user reads “bat” instead of “cat”, clearly the user 140 did not read the word as expected and a reading-related insight is identified.

It is to be noted that, with reference to FIG. 9, some of the blocks can be integrated into a consolidated block or can be broken down to a few blocks and/or other blocks may be added. It should be also noted that whilst the flow diagram is described also with reference to the system elements that realizes them, this is by no means binding, and the blocks can be performed by elements other than those described herein.

Turning to FIG. 10, there is shown a flowchart illustrating one example of a sequence of operations carried out for identifying pressure related reading insights, in accordance with the presently disclosed subject matter.

According to some examples of the presently disclosed subject matter, system 10 can be configure to perform a pressure related reading insights identification process 1000, e.g. utilizing the reading analysis module 260.

For that purpose, system 10 can be configured to obtain a value indicative of a current applied pressure (block 1010) the user's 140 finger is applying on the user device 100 at a given time (e.g. as he is moving his finger over the content's elements that he is reading in real time). The indication can be obtained by a pressure sensor of the user device 100.

In some cases, the system 10 can be further configured to compare the obtained value to an expected amount of pressure the specific user's 140 finger is expected to apply on the user device 100 at the same given time (block 1020). In some cases, the expected pressure level can be a given pressure level (or a given range of pressure levels) that is pre-determined by the system 10 utilizing measurements obtained from past readings by the specific user 140 (e.g. an average pressure level applied by the specific user 140 during reading content presented to it by system 10 in the past). It is to be noted that the expected amount of pressure can be user-specific, as different users can apply different pressure on a pressure sensor, even in identical situations.

If the obtained value is equal to the expected amount of pressure the specific user's 140 finger is expected to apply on the user device 100 at the same given time—the process ends (block 1030), however, if the obtained value is not equal to the expected amount of pressure the specific user's 140 finger is expected to apply on the user device 100 at the same given time, the system 10 can be configured to store a reading-related insight in the data repository 240 (block 1040), including the obtained value, information of the position at which the obtained value was obtained and the element presented at that position, the context (e.g. the sentence comprising the element presented at that position), etc. Such reading-related insight can be utilized by the system 10 when creating the user reading profile as detailed herein with reference to FIG. 3.

Looking again at the simplistic example where the user 140 is presented with a sentence “the dog and the cat are very good friends”, assuming the user applies an unusual amount of pressure prior to or during, or immediately after reading the word “friends”, it is possible that the user 140 is having a difficulty reading this word or a certain type of words with which the word is associated.

It is to be noted that, with reference to FIG. 10, some of the blocks can be integrated into a consolidated block or can be broken down to a few blocks and/or other blocks may be added. It should be also noted that whilst the flow diagram is described also with reference to the system elements that realizes them, this is by no means binding, and the blocks can be performed by elements other than those described herein.

Attention is drawn to FIG. 11 showing a flowchart illustrating one example of a sequence of operations carried out for mental status related reading insights, in accordance with the presently disclosed subject matter.

According to some examples of the presently disclosed subject matter, system 10 can be configure to perform an mental status related reading insights identification process 1100, e.g. utilizing the reading analysis module 260.

For that purpose, system 10 can be configured to obtain a value indicative of a current mental status of the user 140 (block 1110). The value can be obtained, for example, by analyzing one or more images of the user's 140 face and/or other body parts, obtained during reading the content by the user 140. The analysis of the images can be manual or automatic (e.g. using known methods and techniques).

In some cases, the system 10 can be further configured to compare the obtained value to an expected value indicative of an expected mental statue of the user 140 (block 1020).

If the obtained value is equal to the expected value—the process ends (block 1130), however, if the obtained value is not equal to the expected value, the system 10 can be configured to store a reading-related insight in the data repository 240 (block 1140), including the obtained value, information of the position at which the obtained value was obtained and the element presented at that position, the context (e.g. the sentence comprising the element presented at that position), etc. Such reading-related insight can be utilized by the system 10 when creating the user reading profile as detailed herein with reference to FIG. 3.

Looking again at the simplistic example where the user 140 is presented with a sentence “the dog and the cat are very good friends”, assuming the user 140 facial expressions indicate that the user is anxious when reading the word “friends”, it is possible that the user 140 is having a difficulty reading this word. It is to be noted that in some cases false determinations of the current mental status of the user 140 can be made by the system 10 (e.g. as the user 140 made a random facial expression, etc.), so in some cases, as indicated herein, a supporting insight (e.g. a value indicative of a current applied pressure (block 1010) the user's 140 finger is applying on the user device 100 at a given time is not equal to an expected amount of pressure the specific user's 140 finger is expected to apply on the user device 100 at the same given time) may be required in order to store the reading related insight in the data repository 240.

It is to be noted that, with reference to FIG. 11, some of the blocks can be integrated into a consolidated block or can be broken down to a few blocks and/or other blocks may be added. It should be also noted that whilst the flow diagram is described also with reference to the system elements that realizes them, this is by no means binding, and the blocks can be performed by elements other than those described herein.

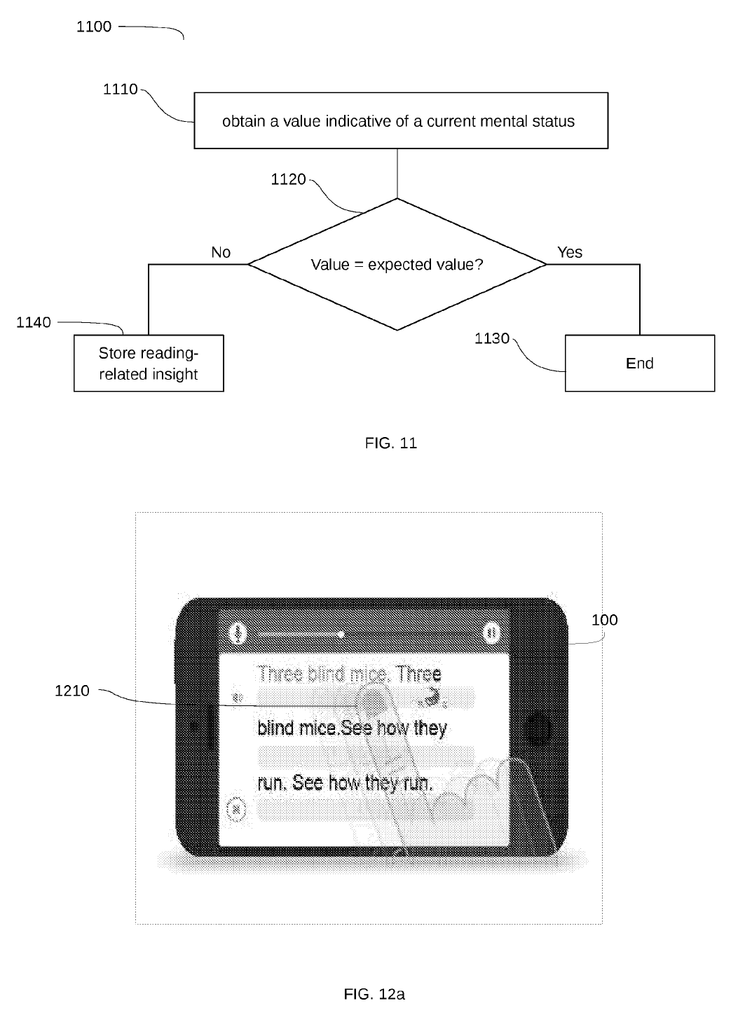

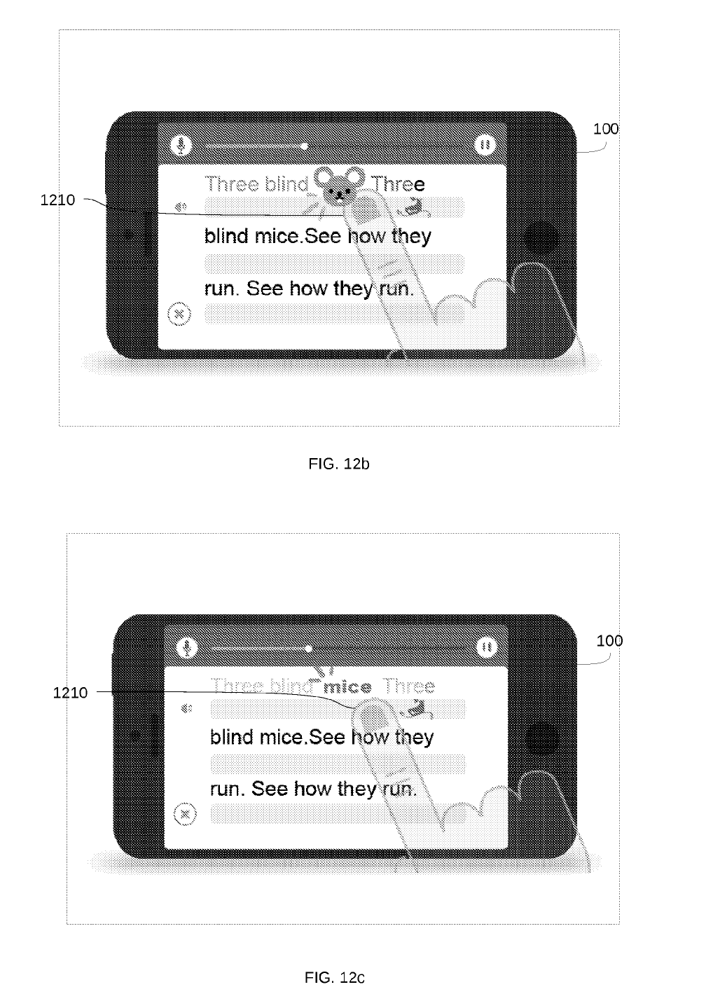

Having described the presently disclosed subject matter, attention is now drawn to FIGS. 12a to 12c. In FIG. 12a, there is shown an exemplary display of non-manipulated content, in accordance with the presently disclosed subject matter. In the illustrated example, an exemplary user interface is presented, in which content for reading is displayed on a display of a user device 100. The content is textual content, which reads “Three blind mice. Three blind mice. See how they run. See how they run.”. In the illustration, there is also shown the user's 140 finger 1210 that is moving over the text in correlation with the user's 140 reading. In the illustrated example, the user's 140 finger 1210 is over the first occurrence of the word “mice”, which indicates that user 140 is now reading the first occurrence of the word “mice”. FIG. 12b is an exemplary display of a manipulated content, in accordance with the presently disclosed subject matter. Based on the user's 140 reading profile, the system 10 provides the user with the same content as provided in FIG. 12a, but with a certain visual manipulation of replacing the first occurrence of the word “mice” with a picture of a mouse. FIG. 12c is another exemplary display of a manipulated content, in accordance with the presently disclosed subject matter. In FIG. 12b, based on the user's 140 reading profile, the system 10 provides the user with the same content as provided in FIGS. 12a (and 12b), but with a different visual manipulation of changing the color of the font of the first occurrence of the word “mice”.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1. A system for providing reading-related feedback, the system comprising a processor configured to:
obtain one or more reading-related inputs relating to reading, by a user, of content displayed to the user, the content comprising a plurality of elements, and the reading-related inputs obtained during reading of the content by the user;
compare the received reading-related inputs to corresponding expected values for identifying one or more reading-related insights; and
perform, based on at least one of the reading-related insights and during reading of the content by the user, at least one manipulation in the display of at least part of at least one element within the content.

2. The system of claim 1 wherein the reading-related insights include one or more error-related insights related to reading errors.

3. The system of claim 2 wherein the manipulation includes one or more of:
(a) changing size of at least part of one or more elements of the content;
(b) changing the font style of at least part of one or more elements of the content;
(c) changing the font family of at least part of one or more elements of the content;
(d) changing the font color of at least part of one or more elements of the content;
(e) changing the case of at least part of one or more elements of the content;
(f) highlighting at least part of one or more elements of the content;
(g) replacing one or more elements of the content with an image;
(h) changing the space between the elements or parts thereof; and
(i) changing the font density of at least part of one or more elements of the content.

4-6. (canceled)

7. The system of claim 1 wherein the reading-related inputs are obtained using a plurality of sensors of a user device operated by the user.

8. The system of claim 7 wherein the sensors include two or more of the following:
(a) a touch sensor;
(b) a microphone;
(c) a pressure sensor;
(d) a camera;
(e) a Galvanic Skin Response (GSR) sensor;
(f) a heart rate sensor;
(g) a pulse sensor.

9. The system of claim 8 wherein the reading-related inputs include an indication of a current reading position obtained utilizing the touch sensor and wherein the corresponding expected value is an expected current reading position.

10. The system of claim 8 wherein the reading related-inputs include a voice-to-text value of an audio recording of the user's voice reading a given element of the elements, the audio recording obtained utilizing the microphone, and wherein the corresponding expected value is an expected text.

11. The system of claim 10 wherein the voice-to-text value is obtained automatically using an automatic voice-to-text converter.

12. The system of claim 8 wherein the reading-related inputs include an indication of a current applied pressure obtained utilizing the pressure sensor and wherein the corresponding expected value is an expected current applied pressure.

13. The system of claim 8 wherein the reading-related inputs include a value indicative of a current mental status obtained by automatically analyzing an image of the user's face, the image obtained utilizing the camera, and wherein the corresponding expected value is indicative of an expected current mental status.

14-18. (canceled)

19. A method of providing reading-related feedback, the method comprising:
obtaining one or more reading-related inputs relating to reading, by a user, of content displayed to the user, the content comprising a plurality of elements, and the reading-related inputs obtained during reading of the content by the user;
comparing, by a processor, the received reading-related inputs to corresponding expected values for identifying one or more reading-related insights; and
performing, by the processor, based on at least one of the reading-related insights and during reading of the content by the user, at least one manipulation in the display of at least part of at least one element within the content.

20. The method of claim 19 wherein the reading-related insights include one or more error-related insights related to reading errors.

21. The method of claim 20 wherein the manipulations includes one or more of:
(a) changing size of at least part of one or more elements of the content;
(b) changing the font style of at least part of one or more elements of the content;
(c) changing the font family of at least part of one or more elements of the content;
(d) changing the font color of at least part of one or more elements of the content;
(e) changing the case of at least part of one or more elements of the content;
(f) highlighting at least part of one or more elements of the content;
(g) replacing one or more elements of the content with an image;
(h) changing the space between the elements or parts thereof; and
(i) changing the font density of at least part of one or more elements of the content.

22-24. (canceled)

25. The method of claim 19 wherein the reading-related inputs are obtained using a plurality of sensors of a user device operated by the user.

26. The method of claim 19 wherein the sensors include two or more of the following:
(a) a touch sensor,
(b) a microphone;
(c) a pressure sensor;
(d) a camera;
(h) a Galvanic Skin Response (GSR) sensor;
(i) a heart rate sensor;
(j) a pulse sensor.

27. The method of claim 26 wherein the reading-related inputs include an indication of a current reading position obtained utilizing the touch sensor and wherein the corresponding expected value is an expected current reading position.

28. The method of claim 26 wherein the reading related-inputs include a voice-to-text value of an audio recording of the user's voice reading a given element of the elements, the audio recording obtained utilizing the microphone, and wherein the corresponding expected value is an expected text.

29. (canceled)

30. The method of claim 26 wherein the reading-related inputs include an indication of a current applied pressure obtained utilizing the pressure sensor and wherein the corresponding expected value is an expected current applied pressure.

31. The method of claim 26 wherein the reading-related inputs include a value indicative of a current mental status obtained by automatically analyzing an image of the user's face, the image obtained utilizing the camera, and wherein the corresponding expected value is indicative of an expected current mental status.

32-36. (canceled)

37. A non-transitory computer readable storage medium having computer readable program code embodied therewith, the computer readable program code, executable by at least one processor of a computer to perform a method comprising:
obtaining one or more reading-related inputs relating to reading, by a user, of content displayed to the user, the content comprising a plurality of elements, and the reading-related inputs obtained during reading of the content by the user;
comparing, by a processor, the received reading-related inputs to corresponding expected values for identifying one or more reading related insights; and
performing by the processor, based on at least one of the reading-related insights and during reading of the content by the user, at least one manipulation in the display of at least part of at least one element within the content.

38-95. (canceled)
